(19) United States
(12) Patent Application Publication
(10) Pub. No.: US 2015/0140435 A1
(43) Pub. Date: May 21, 2015

(54) RECHARGEABLE LITHIUM BATTERY

(71) Applicant: SAMSUNG SDI CO., LTD., Yongin-si (KR)

(72) Inventors: Jea-Woan LEE, Suwon-si (KR); In-Seop BYUN, Suwon-si (KR); Chan HONG, Suwon-si (KR); Soo-Mi EO, Suwon-si (KR); Seung-Hee PARK, Suwon-si (KR)

(21) Appl. No.: 14/524,492

(22) Filed: Oct. 27, 2014

(30) Foreign Application Priority Data
Nov. 20, 2013 (KR) 10-2013-0141455

(51) Int. Cl. H01M 4/36; H01M 10/0525; H01M 4/134; H01M 4/133; H01M 4/38; H01M 4/587

(52) U.S. Cl. CPC H01M 4/364; H01M 4/386; H01M 4/587; H01M 4/134; H01M 4/133; H01M 10/0525; H01M 2004/027
USPC 429/231.4

(57) ABSTRACT

A rechargeable lithium battery including a negative electrode, the negative electrode including a silicon-based material and graphite; a positive electrode; and an electrolyte, wherein the negative electrode includes silicon in an amount of greater than 0 wt % and less than or equal to about 2 wt %, based on a total weight of the silicon-based material and the graphite, and the rechargeable lithium battery has a discharge cut-off voltage of greater than or equal to about 3.1 V.

### CROSS-REFERENCE TO RELATED APPLICATION

Korean Patent Application No. 10-2013-0141455 filed on Nov. 20, 2013, in the Korean Intellectual Property Office, and entitled: “RECHARGEABLE LITHIUM BATTERY,” is incorporated by reference herein in its entirety.

### BACKGROUND

1. Field

Embodiments relate to a rechargeable lithium battery.

2. Description of the Related Art

A rechargeable lithium rechargeable battery has recently drawn attention as a power source for small portable electronic devices. It may use an organic electrolyte solution, and may have twice or more high discharge voltage than that of a battery that uses an alkali aqueous solution and accordingly, may have a high energy density.

This rechargeable lithium battery may be used by injecting an electrolyte into an electrode assembly including a positive electrode including a positive active material that can intercalate and deintercalate lithium, and a negative electrode including a negative active material that can intercalate and deintercalate lithium.

### SUMMARY

Embodiments are directed to a rechargeable lithium battery.

The embodiments may be realized by providing a rechargeable lithium battery including a negative electrode, the negative electrode including a silicon-based material and graphite; a positive electrode; and an electrolyte, wherein the negative electrode includes silicon in an amount of greater than 0 wt % to about 2 wt %, based on a total weight of the silicon-based material and the graphite, and the rechargeable lithium battery has a discharge cut-off voltage of greater than or equal to about 3.1 V.

The negative electrode may include the silicon in an amount of about 0.1 wt % to about 2 wt %, based on the total weight of the silicon-based material and the graphite.

The discharge cut-off voltage may be about 3.1 V to about 3.4 V.

The silicon-based material may include silicon, SiOₓ, in which 0<x<2, a Si—Y alloy, in which Y is an element selected from an alkali metal, an alkaline-earth metal, Group 13 to 16 elements, a transition metal, a rare earth element, and a combination thereof, and is not silicon, a Si—C composite, or a combination thereof.

The silicon-based material may include the SiOₓ, in which 0<x<2.

The silicon-based material may include SiO.

The silicon-based material may be included in an amount of greater than 0 wt % to about 3 wt %, based on the total weight of the silicon-based material and the graphite.

The silicon-based material may be included in an amount of about 0.1 wt % to about 2.8 wt %, based on the total weight of the silicon-based material and the graphite.

The rechargeable lithium battery may have a unit cell structure.

### BRIEF DESCRIPTION OF THE DRAWINGS

Features will be apparent to those of skill in the art by describing in detail exemplary embodiments with reference to the attached drawings in which:

FIG. 1 illustrates a schematic view of a rechargeable lithium battery according to one embodiment.

FIG. 2 illustrates a graph showing discharge capacity of rechargeable lithium battery cells according to Examples 1 to 6 and Comparative Examples 1 to 3, depending on a discharge cut-off voltage.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout.

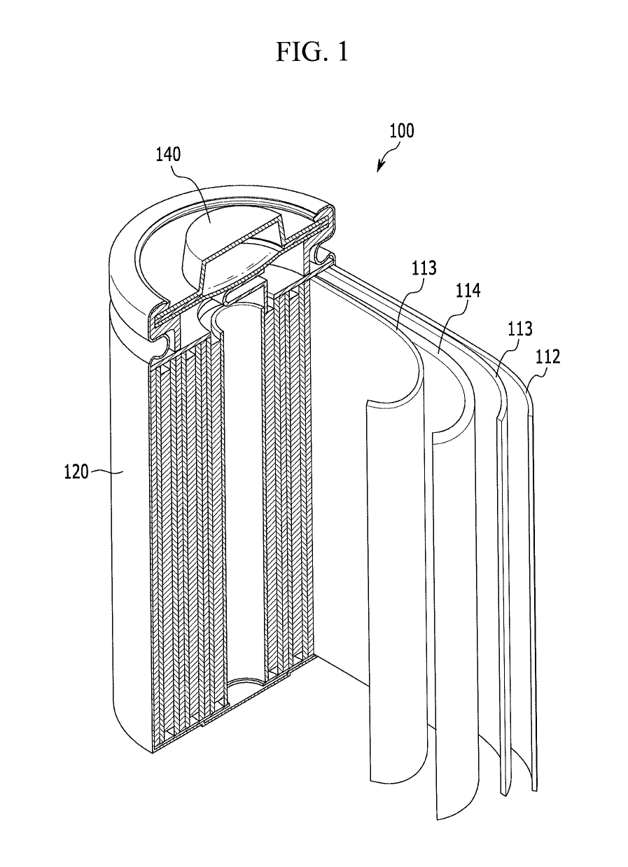

A rechargeable lithium battery according to one embodiment is described referring to FIG. 1. FIG. 1 illustrates a schematic view of a rechargeable lithium battery according to one embodiment.

Referring to FIG. 1, a rechargeable lithium battery 100 according to one embodiment may include an electrode assembly (including a positive electrode 114, a negative electrode 112 facing the positive electrode 114, a separator 113 interposed between the negative electrode 112 and the positive electrode 114), an electrolyte (not shown) impregnating the positive electrode 114, the negative electrode 112, and the separator 113, a battery case 120 accommodating the electrode assembly, and a sealing member 140 sealing the battery case 120.

The negative electrode 112 may include a negative current collector and a negative active material layer on the negative current collector.

The negative current collector may be, e.g., a copper foil, a nickel foil, a stainless steel foil, a titanium foil, a nickel foam, a copper foam, a polymer substrate coated with a conductive metal, or a combination thereof.

The negative active material layer may include, e.g., a negative active material and a binder. In an implementation, the negative active material may further include, e.g., a conductive material.

The negative active material may include a silicon (Si)-based material and graphite. When the Si-based material is mixed with the graphite, irreversible and expansion characteristics of the Si-based material may be alleviated, and capacity of a cell may be increased, resultantly obtaining high-capacity.

The Si-based material may include, e.g., Si, SiOₓ (in which 0<x<2), a Si—Y alloy (in which Y is an element selected from an alkali metal, an alkaline-earth metal, Group 13 to 16 elements, a transition metal, a rare earth element, and a combination thereof, and not Si), a Si—C composite, or a combination thereof. In an implementation, Y may be selected from, e.g., Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, or a combination thereof. In an implementation, the SiOₓ (in which 0<x<2) may be used.

The Si-based material be included in the negative active material in an amount of greater than 0 wt % to about 3 wt %, e.g. about 0.1 wt % to about 2.8 wt %, about 0.1 wt % to about 2.4 wt %, or about 0.1 wt % to about 1.9 wt %, based on a total weight of the Si-based material and the graphite.

In an implementation, the negative electrode may include a Si element, e.g., silicon, in the Si-based material in the negative active material. The silicon may be included in an amount of greater than 0 wt % to about 2 wt %, e.g., about 0.1 wt % to about 2 wt %, about 0.1 wt % to about 1.8 wt %, about 0.1 wt % to about 1.5 wt %, or about 0.1 wt % to about 1.2 wt %, based on the total weight of the Si-based material and the graphite.

When the silicon is included within the range in the negative electrode, theoretical capacity of the Si-based material (despite its high discharge potential) may be used without decreasing a discharge cut-off voltage of a battery. Accordingly, high-capacity characteristics of the Si-based material may be maximized without lowering a discharge cut-off voltage. Thus, high-capacity may be realized in a device such as a smart phone.

In an implementation, the cell may have a discharge cut-off voltage of greater than or equal to about 3.1V, e.g., about 3.1V to about 3.4V, or about 3.2V to about 3.4V. When the cell has a discharge cut-off voltage within the range, the Si-based material may be applied to an IT device, e.g., a smart phone or the like. For example, the rechargeable battery according to an embodiment may be operated at a discharge cut-off voltage of greater than or equal to about 3.1V.

The rechargeable lithium battery may have a unit cell structure. In an implementation, a battery system may include the lithium rechargeable battery according to an embodiment.

The binder may help improve binding properties of negative active material particles with one another and with a current collector. The binder may include a non-water-soluble binder, a water-soluble binder, or a combination thereof.

Non-limiting examples of the non-water-soluble binder may include polyvinylchloride, carboxylated polyvinylchloride, polyvinyl fluoride, ethylene oxide-containing polymers, polyvinylpyrrolidone, polyurethane, polytetrafluoroethylene, polyvinylidene fluoride, polyethylene, polypropylene, polyamideimide, polyimide, and combinations thereof.

Non-limiting examples of the water-soluble binder may include styrene-butadiene rubbers, acrylated styrene-butadiene rubbers, polyvinyl alcohol, sodium polyacrylate, copolymers of propylene and a C2 to C8 olefin, copolymers of (meth)acrylic acid and (meth)acrylic acid alkyl ester, and combinations thereof.

When a water-soluble binder is used as the negative electrode binder, a cellulose-based compound may also be included to provide viscosity. The cellulose-based compound may include one or more of carboxymethyl cellulose, hydroxypropylmethyl cellulose, methyl cellulose, and alkali metal salts thereof. The alkali metal may be Na, K, or Li. The cellulose-based compound may be included in an amount of about 0.1 to about 3 parts by weight based on 100 parts by weight of the negative active material.

The conductive material may help improve conductivity of an electrode. A suitable electrically conductive material that does not cause a chemical change may be used as a conductive material. Examples of the conductive material may include a carbon-based material such as natural graphite, artificial graphite, carbon black, acetylene black, ketjen black, carbon fiber and the like; metal-based material such as a metal powder or a metal fiber and the like of copper, nickel, aluminum, silver, and the like; a conductive polymer such as a polyphenylene derivative and the like; or a mixture thereof.

The positive electrode 114 may include a positive current collector and a positive active material layer on the positive current collector. The positive active material layer may include a positive active material and a binder. In an implementation, the positive active material may further include a conductive material.

The positive current collector may use, e.g., Al (aluminum).

The positive active material may include lithiated intercalation compounds that reversibly intercalate and deintercalate lithium ions. For example, at least one composite oxide of lithium and metal of cobalt, manganese, nickel, or a combination thereof may be used. Examples may include compounds represented by one of the following chemical formulae:

LiₐA_{1-b}B_{b}D₂ (0.90≦a≦1.8 and 0≦b≦0.5); LiₐE₁₋bB_{b}O_{2-c}D_{c} (0.90≦a≦1.8, 0≦b≦0.5, 0≦c≦0.05); LiₐE_{2-b}B_{b}O_{4-c}D_{c} (0.90≦a≦1.8, 0≦b≦0.5, 0≦c≦0.05); LiₐNi_{1-b-c}Co_{b}B_{c}D_{α} (0.90≦a≦1.8, 0≦b≦0.5, 0≦c≦0.05, 0≦α≦2); LiₐNi_{1-b-c}Co_{b}B_{c}O_{2-α}F_{α} (0.90≦a≦1.8, 0≦b≦0.5, 0≦c≦0.05, 0<α<2); LiₐNi_{1-b-c}Co_{b}B_{c}O_{2-α}F₂ (0.90≦a≦1.8, 0≦b≦0.5, 0≦c≦0.05, 0<α<2); LiₐNi_{1-b-c}Mn_{b}B_{c}D_{α} (0.90≦a≦1.8, 0≦b≦0.5, 0≦c≦0.05, 0<α<2); LiₐNi_{1-b-c}Mn_{b}B_{c}O_{2-α}F_{α} (0.90≦a≦1.8, 0≦b≦0.5, 0≦c≦0.05, 0<α<2); LiₐNi_{1-b-c}Mn_{b}B_{c}O_{2-α}F₂ (0.90≦a≦1.8, 0≦b≦0.5, 0≦c≦0.05, <α—2); LiₐNi_{b}E_{c}G_{d}O₂ (0.90≦a≦1.8, 0≦b≦0.9, 0≦c≦0.5, 0.001≦d≦0.1); LiₐNi_{b}Co_{c}Mn_{d}GₑO₂ (0.90≦a≦1.8, 0≦b≦0.9, 0≦c≦0.5, 0≦d≦0.5, 0.001≦e≦0.1); LiₐNiG_{b}O₂ (0.90≦a≦1.8, 0.001≦b≦0.1); LiₐCoG_{b}O₂ (0.90≦a≦1.8, 0.001≦b≦0.1); LiₐMnG_{b}O₂ (0.90≦a≦1.8, 0.001≦b≦0.1); LiₐMn₂G_{b}O₄ (0.90≦a≦1.8, 0.001≦b≦0.1); LiV₂O₅; LiIO₂; LiNiVO₄; Li_{(3-f)}J₂(PO₄)₃ (0≦f≦2); Li_{(3-f)}Fe₂(PO₄)₃ (0≦f≦2); and LiFePO₄.

In the above chemical formulae, A may be selected from Ni, Co, Mn, or a combination thereof; B may be selected from Al, Ni, Co, Mn, Cr, Fe, Mg, Sr, V, a rare earth element, or a combination thereof; D may be selected from O, F, S, P, or a combination thereof; E may be selected from Co, Mn, or a combination thereof; F may be selected from F, S, P, or a combination thereof; G may be selected from Al, Cr, Mn, Fe, Mg, La, Ce, Sr, V, or a combination thereof; Q may be selected from Ti, Mo, Mn, or a combination thereof; I may be selected from Cr, V, Fe, Sc, Y, or a combination thereof; and J may be selected from V, Cr, Mn, Co, Ni, Cu, or a combination thereof.

The positive active material may include, e.g., lithium cobalt oxide, lithium nickel cobalt manganese oxide, lithium nickel cobalt aluminum oxide, or a combination thereof.

The binder may help improve binding properties of the positive active material particles with each other, and the positive active material with a positive current collector. Examples of the binder may include polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like.

The conductive material may help improve conductivity of an electrode. A suitable electrically conductive material that does not cause a chemical change may be used as the conductive material. Examples of the conductive material may include a carbon-based material such as natural graphite, artificial graphite, carbon black, acetylene black, ketjen black, a carbon fiber, and the like; a metal-based material such as a metal powder or a metal fiber and the like of copper, nickel, aluminum, silver, and the like; a conductive polymer of a polyphenylene derivative and the like; or a mixture thereof.

The positive electrode and negative electrode may be manufactured by mixing each active material, a conductive material, and a binder in a solvent to prepare an active material composition, and applying the composition on a current collector. The solvent may include, e.g., N-methylpyrrolidone or the like.

The electrolyte may include a non-aqueous organic solvent and a lithium salt.

The non-aqueous organic solvent may serve as a medium for transmitting ions taking part in the electrochemical reaction of a battery. The non-aqueous organic solvent may be selected from a carbonate-based, ester-based, ether-based, ketone-based, alcohol-based, or aprotic solvent.

The carbonate based solvent may include, e.g., dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), butylene carbonate (BC), or the like.

For example, when the linear carbonate compounds and cyclic carbonate compounds are mixed, an organic solvent having a high dielectric constant and a low viscosity may be provided. The cyclic carbonate compound and the linear carbonate compound may be mixed together in a volume ratio of about 1:1 to about 1:9.

In an implementation, the ester-based solvent may include, e.g., methylacetate, ethylacetate, n-propylacetate, dimethylacetate, methylpropionate, ethylpropionate, γ-butyrolactone, decanolide, valerolactone, mevalonolactone, caprolactone, and the like. The ether-based solvent may be, for example dibutylether, tetraglyme, diglyme, dimethoxyethane, 2-methyltetrahydrofuran, tetrahydrofuran, and the like, and the ketone-based solvent may be cyclohexanone, or the like. In an implementation, the alcohol-based solvent may include, e.g., ethanol, isopropyl alcohol, or the like.

The non-aqueous organic solvent may be used singularly or in a mixture. When the organic solvent is used in a mixture, the mixture ratio may be controlled in accordance with a desirable battery performance.

The lithium salt may be dissolved in an organic solvent, may supply lithium ions in a battery, may operate a basic operation of the rechargeable lithium battery, and may help improve lithium ion transportation between positive and negative electrodes therein.

Examples of the lithium salt may include LiPF₆, LiBF₄, LiSbF₆, LiAsF₆, LiN(SO₃C₂F₅)₂, LiN(CF₃SO₂)₂, LiC₄F₉SO₃, LiClO₄, LiAlO₂, LiAlCl₄, LiN(CₓF₂ₓ₊₁SO₂)(C_{y}F_{2y+1}SO₂) wherein, x and y are natural numbers, e.g. an integer of 1 to 20, LiCl, LiI, LiB(C₂O₄)₂ (lithium bisoxalato borate (LiBOB)), or a combination thereof.

The lithium salt may be used in a concentration of about 0.1 M to about 2.0 M. When the lithium salt is included within the above concentration range, the electrolyte may have excellent performance and lithium ion mobility due to optimal electrolyte conductivity and viscosity.

The separator 113 may include suitable materials that separate a negative electrode 112 from a positive electrode 114 and that provide a transporting passage for lithium ion. For example, the separator 113 may have a low resistance to ion transportation and an excellent impregnation for an electrolyte. In an implementation, the material for the separator may be selected from glass fiber, polyester, TEFLON (tetrafluoroethylene), polyethylene, polypropylene, polytetrafluoroethylene (PTFE), or a combination thereof. The separator may have a form of a non-woven fabric or a woven fabric. For example, a polyolefin-based polymer separator such as polyethylene, polypropylene or the like may be used for a lithium ion battery. In order to ensure the heat resistance or mechanical strength, a coated separator including a ceramic component or a polymer material may be used. In an implementation, the separator may have a mono-layered or multi-layered structure.

The rechargeable lithium battery may have a unit cell structure.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Examples 1 to 6 and Comparative Examples 1 to 3

### Manufacture of Positive Electrode

A positive active material layer composition was prepared by mixing LiCoO₂, polyvinylidene fluoride (PVdF), and carbon black in a weight ratio of 96:2:2 and dispersing the mixture into N-methyl-2-pyrrolidone. The positive active material layer composition was coated on a 20 μm-thick aluminum foil and then, dried and compressed, manufacturing a positive electrode.

(Manufacture of Negative Electrode)

Negative active material layer compositions were prepared by mixing 96 wt % of negative active materials obtained by mixing SiO and graphite in a weight ratio of the following Table 1, 2 wt % of a styrene butadiene rubber (SBR), and 2 wt % of carboxylmethyl cellulose and dispersing the mixture into water. The negative active material layer compositions were coated on a 15 μm-thick copper foil and then dried and compressed, manufacturing negative electrodes.

(Preparation of Electrolyte)

An electrolyte was prepared by mixing ethylene carbonate (EC), ethylmethyl carbonate (EMC), and diethyl carbonate (DEC) in a volume ratio of 3:5:2 and dissolving 1.3M of LiPF6 in the mixed solvent.

(Manufacture of Rechargeable Lithium Battery Cell)

The positive and negative electrodes and an 18 μm-thick polyethylene separator were spirally wound to manufacture an electrode assembly. Subsequently, the electrode assembly was housed in a battery case, and the electrolyte was injected into the battery case, manufacturing a rechargeable lithium battery cell.

TABLE 1

| | | Amount of silicon based on |
|---|---|---|
| | Weight ratio of | the total amount of SiO |
| | SiO:graphite | and graphite (wt %) |
| Example 1 | 0.5:99.5 | 0.32 |
| Example 2 | 1:99 | 0.64 |
| Example 3 | 1.5:98.5 | 0.96 |
| Example 4 | 2:98 | 1.28 |
| Example 5 | 2.5:97.5 | 1.6 |
| Example 6 | 3:97 | 1.92 |
| Comparative | 0:100 | 0 |
| Example 1 | | |
| Comparative | 4:96 | 2.56 |
| Example 2 | | |
| Comparative | 5:95 | 3.2 |
| Example 3 | | |

Evaluation 1: Capacity Evaluation of Rechargeable Lithium Battery Cell

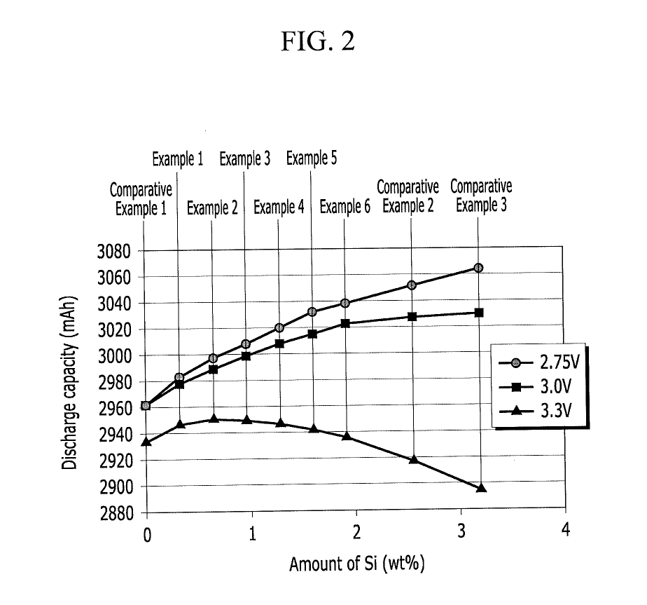

The rechargeable lithium battery cells according to Examples 1 to 6 and Comparative Examples 1 to 3 were charged with CC/CV at 0.5 C up to 4.35V and discharged at 0.2 C under each cut-off condition of 2.75V, 3.0V, and 3.3V, as shown in FIG. 2. Discharge capacity of the rechargeable lithium battery cells according to Examples 1 to 6 and Comparative Examples 1 to 3 was evaluated depending on each discharge cut-off voltage, and the results are provided in FIG. 2.

FIG. 2 illustrates a graph showing the discharge capacity of the rechargeable lithium battery cells according to Examples 1 to 6 and Comparative Examples 1 to 3 depending on a discharge cut-off voltage.

Referring to FIG. 2, capacity gradually increased as the amount of the Si-based element increased at a discharge cut-off voltage of 2.75V and 3.0V, at which discharge capacity of the Si-based material might be sufficiently used. The advantage regarding capacity disappeared due to decreased efficiency of the cell when the discharge cut-off voltage was increased to 3.3V. Accordingly, when the lithium rechargeable battery cells included silicon in an amount of greater than 0 to 2 wt %, as in Examples 1 to 6, theoretical capacity of the Si-based material was at most used at a discharge cut-off voltage of greater than or equal to 3.1 V. The lithium rechargeable battery cells according to Comparative Examples 1 to 3 included no silicon, or the silicon was out of the range at a discharge cut-off voltage of greater than or equal to 3.1 V, and capacity of the battery cells sharply decreased.

By way of summation and review, for the negative active material, a silicon (Si)-based material may be used as a high-capacity material. The Si-based material may have large irreversible capacity and may be limitedly used alone. Accordingly, a mixture of the Si-based material with other active materials, e.g., graphite, may be less reversible and expanded than the Si-based material alone. Thus, the capacity of a battery may increase.

The Si-based material may have a high discharge potential, and the cell may need to be adjusted to have a low discharge cut-off voltage in order to fully use capacity of the cell. An IT device, e.g., a smart phone or the like, may be designed based on a graphite system and may be hardly discharged down to a low potential. Thus, the Si-based material may hardly accomplish high capacity (as compared with graphite) even if it is a high-capacity material.

The embodiments may provide a rechargeable lithium battery that is capable of realizing high capacity in a device, e.g., a smart phone, by maximizing high-capacity characteristics of a Si-based material without lowering a discharge cut-off voltage.

Accordingly, as high-capacity characteristics of the Si-based material is maximized without lowering a discharge cut-off voltage, a rechargeable battery with a high-capacity capable of being used for a device such as a smart phone may be realized

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A rechargeable lithium battery, comprising:
a negative electrode, the negative electrode including a silicon-based material and graphite;
a positive electrode; and
an electrolyte,
wherein:
the negative electrode includes silicon in an amount of greater than 0 wt % to about 2 wt %, based on a total weight of the silicon-based material and the graphite, and
the rechargeable lithium battery has a discharge cut-off voltage of greater than or equal to about 3.1 V.

2. The rechargeable lithium battery as claimed in claim 1, wherein the negative electrode includes the silicon in an amount of about 0.1 wt % to about 2 wt %, based on the total weight of the silicon-based material and the graphite.

3. The rechargeable lithium battery as claimed in claim 1, wherein the discharge cut-off voltage is about 3.1 V to about 3.4 V.

4. The rechargeable lithium battery as claimed in claim 1, wherein the silicon-based material includes silicon, SiOₓ, in which 0<x<2, a Si—Y alloy, in which Y is an element selected from an alkali metal, an alkaline-earth metal, Group 13 to 16 elements, a transition metal, a rare earth element, and a combination thereof, and is not silicon, a Si—C composite, or a combination thereof.

5. The rechargeable lithium battery as claimed in claim 1, wherein the silicon-based material includes the SiOₓ, in which 0<x<2.

6. The rechargeable lithium battery as claimed in claim 5, wherein the silicon-based material includes SiO.

7. The rechargeable lithium battery as claimed in claim 1, wherein the silicon-based material is included in an amount of greater than 0 wt % to about 3 wt %, based on the total weight of the silicon-based material and the graphite.

8. The rechargeable lithium battery as claimed in claim 1, wherein the silicon-based material is included in an amount of about 0.1 wt % to about 2.8 wt %, based on the total weight of the silicon-based material and the graphite.

9. The rechargeable lithium battery as claimed in claim 1, wherein the rechargeable lithium battery has a unit cell structure.
